(19) United States
(12) Patent Application Publication
(10) Pub. No.: US 2011/0008703 A1
(43) Pub. Date: Jan. 13, 2011

(54) FUEL CELL WITH DEAD-END ANODE

(75) Inventors: Tomohiro Ogawa, Shizuoka-ken (JP); Syo Usami, Shizuoka-ken (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Aichi-Ken (JP)

(21) Appl. No.: 12/446,070

(22) PCT Filed: Jun. 21, 2008
(86) PCT No.: PCT/IB08/01521

§ 371 Date: Apr. 17, 2009

(30) Foreign Application Priority Data
Jun. 14, 2007 (JP) 2007-157039

(51) Int. Cl. H01M 8/10

(52) U.S. Cl. 429/480

(57) ABSTRACT

A fuel cell (100) that generates power without discharging fuel gas includes: an electrolyte membrane (810); an anode (820) provided on one side of the electrolyte membrane; and a fuel-gas passage portion (840) provided on the outer side of the anode to form a fuel-gas supply passage through which fuel gas is supplied to the anode. The gas permeability of at least one of the electrolyte membrane and the anode in a thickness direction thereof varies from position to position in a direction the fuel-gas supply passage extends.

### FIELD OF THE INVENTION

The invention relates to a fuel cell that generates power without discharging fuel gas.

### BACKGROUND OF THE INVENTION

In recent years, fuel cells that generate power through electrochemical reactions between hydrogen and oxygen have been attracting much attention of people. A typical fuel cell has a membrane-electrode assembly (will be referred to as “MEA”) constituted of an electrolyte membrane, an anode provided on one side of the electrolyte membrane, and a cathode provided on the other side of the electrolyte membrane. A passage portion forming a fuel-gas supply passage is provided on the anode. This passage portion is, for example, a conductive porous member. In some cases, the anode and/or the cathode have gas diffusion layers, as well as catalyst layers.

There are demands for minimizing the amount of fuel gas inevitably discharged to the outside of the fuel cell. Thus, fuel cells have been developed which generate power without discharging fuel gas. As one of such fuel cells, Japanese Patent Application Publication No. 2005-190759 (JP-A-2005-190759) describes an anode-dead-end operation type fuel cell (will be referred to as “dead-end operation type fuel cell”).

In a dead-end operation type fuel cell, typically, air, air-oxygen mixture, or the like, is used as the oxidizing gas. In this case, however, there is a possibility that nitrogen and other components in air leak from the cathode side to the anode side. In some cases, such nitrogen and other components that have leaked to the anode (will be referred to “leak gas”) stagnate in the fuel-gas supply passage. If the leak gas stagnates in the fuel-gas supply passage, the fuel gas becomes unable to be supplied dispersedly to the anode (the anode face). In this case, the fuel gas fails to be supplied to some portions of the anode, and therefore power generation is not properly performed at such portions, leading to a decrease in the power generation efficiency of the entire fuel cell.

### SUMMARY OF THE INVENTION

The invention provides a technology that prevents stagnation of leak gas in fuel-gas supply passages in a dead-end operation type fuel cell.

The first aspect of the invention relates to a fuel cell that generates power without discharging fuel gas, having: an electrolyte membrane; an anode provided on one side of the electrolyte membrane; and a fuel-gas passage portion provided on the outer side of the anode to form a fuel-gas supply passage through which fuel gas is supplied to the anode. The gas permeability of at least one of the electrolyte membrane and the anode in a thickness direction thereof varies from position to position in a direction the fuel-gas supply passage extends.

According the fuel cell described above, stagnation of leak gas in the fuel-gas passage can be prevented.

The above-described fuel cell may be such that a portion of the electrolyte membrane that corresponds to the downstream side of the fuel-gas supply passage and a portion of the electrolyte membrane that corresponds to the upstream side of the fuel-gas supply passage are made of different materials.

Further, the above-described fuel cell may be such that the thickness-direction gas permeability of the at least one of the electrolyte membrane and the anode is higher at a portion corresponding to the downstream side of the fuel-gas supply passage than at a portion corresponding to the upstream side of the fuel-gas supply passage.

According to this structure, leak gas does not stagnate in the downstream region of the fuel-gas supply passage, but it returns to the cathode side. Therefore, stagnation of leak gas in the fuel-gas passage can be prevented.

Further, the above-described fuel cell may be such that the thickness of the electrolyte membrane is smaller at a portion corresponding to the downstream side of the fuel-gas supply passage than at a portion corresponding to the upstream side of the fuel-gas supply passage.

According to this structure, leak gas does not stagnate in the downstream region of the fuel-gas supply passage but it returns to the cathode side via the high-gas-permeability portion of the electrolyte membrane. As such, stagnation of leak gas in the fuel-gas passage can be prevented.

Further, the above-described fuel cell may be such that a portion of the electrolyte membrane that corresponds to the downstream side of the fuel-gas supply passage is made of fluorine resin and a portion of the electrolyte membrane that corresponds to the upstream side of the fuel-gas supply passage is made of hydrocarbon resin.

According to this structure, leak gas does not stagnate in the downstream region of the fuel-gas supply passage but it returns to the cathode side via the high-gas-permeability portion of the electrolyte membrane. As such, stagnation of leak gas in the fuel-gas passage can be prevented.

Further, the above-described fuel cell may be such that the porosity of the anode is higher at a portion corresponding to the downstream side of the fuel-gas supply passage than at a portion corresponding to the upstream side of the fuel-gas supply passage.

According to this structure, leak gas does not stagnate in the downstream region of the fuel-gas supply passage but it returns to the cathode side via the high-porosity portion of the anode. As such, stagnation of leak gas in the fuel-gas passage can be prevented.

Further, the above-described fuel cell may be such that a plurality of concave portions is formed on an anode-side face of the electrolyte membrane.

Further, the above-described fuel cell may further have a conductive sheet provided between the anode and the fuel-gas passage portion and having a sheet-like shape and having a plurality of through holes dispersedly formed in a surface of the conductive sheet portion, and a plurality of concave portions may be formed on the electrolyte membrane so as not to overlap the through holes of the conductive sheet portion as viewed in a direction the electrolyte membrane, the anode, and the conductive sheet portion are stacked to form a stack module.

According to this structure, leak gases stagnating between the through holes return to the cathode via the concave portions where the gas permeability is relatively high. As such, leak gas can be prevented from entering the fuel-gas supply passage and therefore leak-gas stagnation does not occur therein.

Further, the above-described fuel cell may be such that the thickness-direction gas permeability of the at least one of the electrolyte membrane and the anode is lower at a portion corresponding to the downstream side of the fuel-gas supply passage than at a portion corresponding to the upstream side of the fuel-gas supply passage.

This structure reduces the amount of leak gas that stagnates in the downstream region of the fuel-gas supply passage.

Further, the above-described fuel cell may be such that the thickness of the electrolyte membrane is larger at a portion corresponding to the downstream side of the fuel-gas supply passage than at a portion corresponding to the upstream side of the fuel-gas supply passage.

Further, the above-described fuel cell may be such that a portion of the electrolyte membrane that corresponds to the downstream side of the fuel-gas supply passage is made of hydrocarbon resin and a portion of the electrolyte membrane that corresponds to the upstream side of the fuel-gas supply passage is made of fluorine resin.

Further, the above-described fuel cell may be such that the porosity of the anode is lower at a portion corresponding to the downstream side of the fuel-gas supply passage than at a portion corresponding to the upstream side of the fuel-gas supply passage.

Further, the above-described fuel cell may be such that the minimum value of the pressure of fuel gas flowing in the fuel-gas supply passage is set larger than the maximum value of the partial pressure of leak gas that leaks from the cathode side to the fuel-gas supply passage through the electrolyte membrane.

The second aspect of the invention relates to a fuel cell that generates power without discharging fuel gas. This fuel cell has: an electrolyte membrane; an anode provided on one side of the electrolyte membrane; a cathode provided on the other side of the electrolyte membrane; and an oxidizing-gas passage portion provided on the outer side of the cathode to form an oxidizing-gas passage through which oxidizing gas is supplied to the cathode. The gas permeability of the cathode in a thickness direction thereof is higher at a portion corresponding to the downstream side of the oxidizing-gas supply passage than at a portion corresponding to the upstream side of the oxidizing-gas supply passage.

According to the fuel cell described above, leak gas does not stagnate in the downstream region of the fuel-gas supply passage, but it returns to the cathode side. Therefore, stagnation of leak gas in the fuel-gas passage can be prevented.

It is to be noted that applications of the invention are not limited to the fuel cells described above. For example, the invention may be embodied as a fuel-cell manufacturing method.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a view showing the exterior of a fuel cell unit 100 of the first example embodiment;

FIG. 2 is a side view of the fuel cell unit 100;

FIG. 3 is a view showing the structure of each seal-integrated power generation assembly 200 as viewed from the right side of FIG. 2;

FIG. 4 is a cross-sectional view taken along line IV-IV in FIG. 3;

FIG. 5 is a view illustrating the shape of a cathode plate 400 of a separator 600;

FIG. 6 is a view illustrating the shape of an anode plate 300 of the separator 600;

FIG. 7 is a view illustrating the shape of an intermediate plate 500 of the separator 600;

FIG. 8 is an elevation view of the separator 600;

FIG. 9A and FIG. 9B are views showing the reaction gas flows in the fuel cell unit 100 of the first example embodiment;

FIG. 10 is an enlarged view of the region X in FIG. 9A;

FIG. 11 is a view showing an electrolyte membranes 810A in a fuel cell unit 100A of the second example embodiment;

FIG. 12 is a schematic cross-sectional view of each electrolyte membrane 810A;

FIG. 13 is a schematic cross-sectional view of an electrolyte membrane 810B and an anode 820α of a fuel cell unit 100B of the third example embodiment;

FIG. 14A and FIG. 14B are schematic cross-sectional views of the fuel cell unit 100C;

FIG. 15 is an elevation view of a conductive sheet 860 as seen from the upper side of FIG. 14A and FIG. 14B;

FIG. 16 is an enlarged view of the region Z in FIG. 14A and FIG. 14B;

FIG. 17 is a view showing an electrolyte membrane 810C as seen from the upper side of the FIG. 14A and FIG. 14B;

FIG. 18 is a schematic cross-sectional view of a fuel cell unit according to the first modification example;

FIG. 19 is a schematic cross-sectional view of a fuel cell unit according to the second modification example; and

FIG. 20 is a schematic cross-sectional view of a fuel cell unit according to the third modification example.

### DETAILED DESCRIPTION OF THE EMBODIMENTS

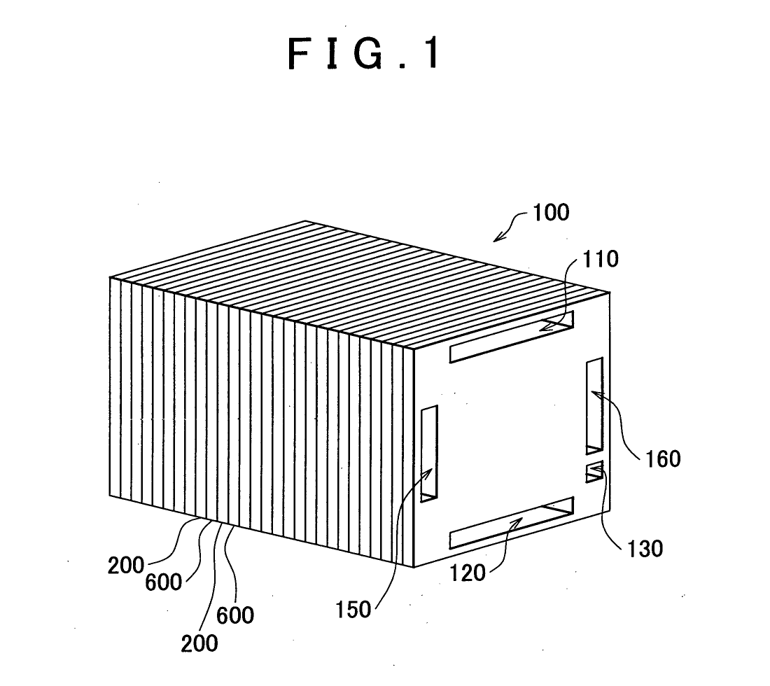

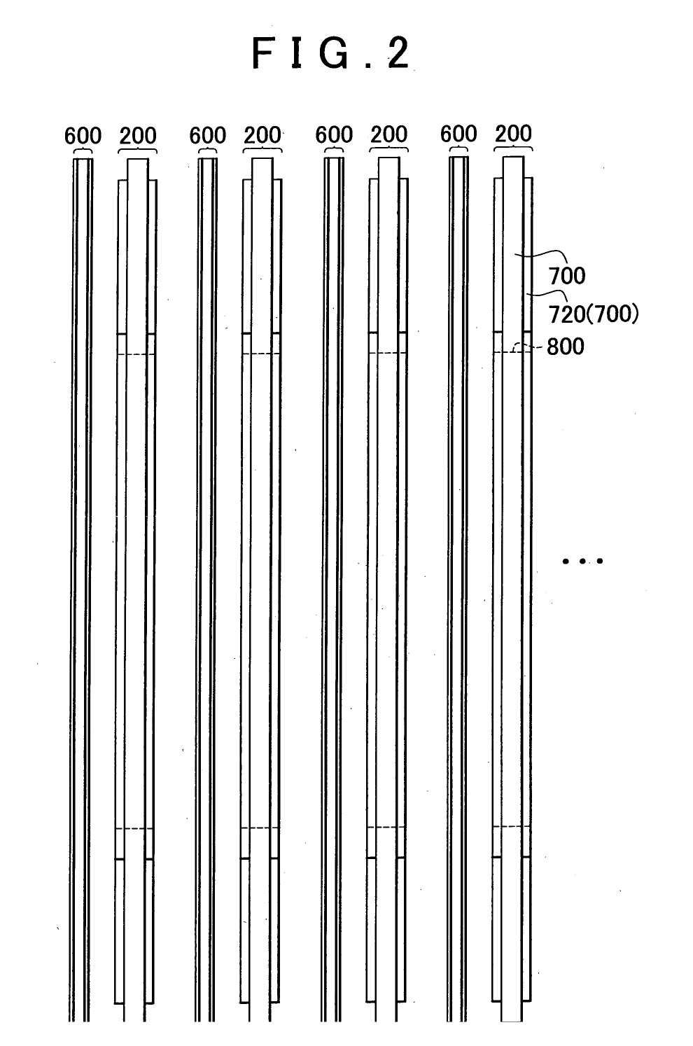

The outline of the configuration of a fuel cell unit 100 according to the first example embodiment of the invention will be described. FIG. 1 shows the exterior of the fuel cell unit 100 of the first example embodiment, and FIG. 2 shows a side view of the fuel cell unit 100. Referring to FIG. 1 or FIG. 2, the fuel cell unit 100 is a so-called fuel cell stack constituted of seal-integrated power generation assemblies 200 and separators 600 alternately stacked on top of each other. When manufacturing the fuel cell unit 100, a certain number of the seal-integrated power generation assemblies 200 and a certain number of the separators 600 are stacked, and then they are cramped at a given cramping pressure in the direction they are stacked. Although FIG. 2 shows spaces between the seal-integrated power generation assemblies 200 and the separators 600, these spaces do no exist, that is, the seal-integrated power generation assemblies 200 and the separators 600 are actually in contact with each other. In this description, the direction the seal-integrated power generation assemblies 200 and the separators 600 are stacked will be referred to as “stacking direction” where necessary. Detail on sealers 700 (ribs 720) will be described later.

Referring to FIG. 1, the fuel cell unit 100 has an oxidizing-gas supply manifold 110 through which oxidizing gas is supplied in the fuel cell unit 100, an oxidizing-gas discharge manifold 120 through which oxidizing gas is discharged from the fuel cell unit 100, a fuel-gas supply manifold 130 through which fuel gas is supplied in the fuel cell unit 100, a coolant supply manifold 150 through which coolant is supplied in the fuel cell unit 100, and a coolant discharge manifold 160 through which coolant is discharged from the fuel cell unit 100. Note that the fuel cell unit 100 is not structured to discharge fuel gas from the anode, that is, the fuel cell unit 100 has a closed structure from which the fuel gas is not discharged to the outside of the fuel cell unit 100 (will be referred to as “dead-end structure” where necessary). That is, in the fuel cell unit 100, no fuel-gas discharge manifold for discharging fuel gas is provided, and therefore power generation is performed without discharging fuel gas. Meanwhile, air is used as the oxidizing gas, and hydrogen is used as the fuel gas. The coolant may be water, antifreeze fluid (e.g., ethylene glycol), air, and so on. As the oxidizing gas, gas obtained by adding high-concentration oxygen to air may be used alternatively. Meanwhile, the dead-end structure can be said to be a structure in which the fuel gas supplied to the seal-integrated power generation assemblies 200 is substantially fully used for the power generation at MEAs (will be described later) although part of the fuel gas permeates to electrolyte membranes, gaskets, and so on (will be described later).

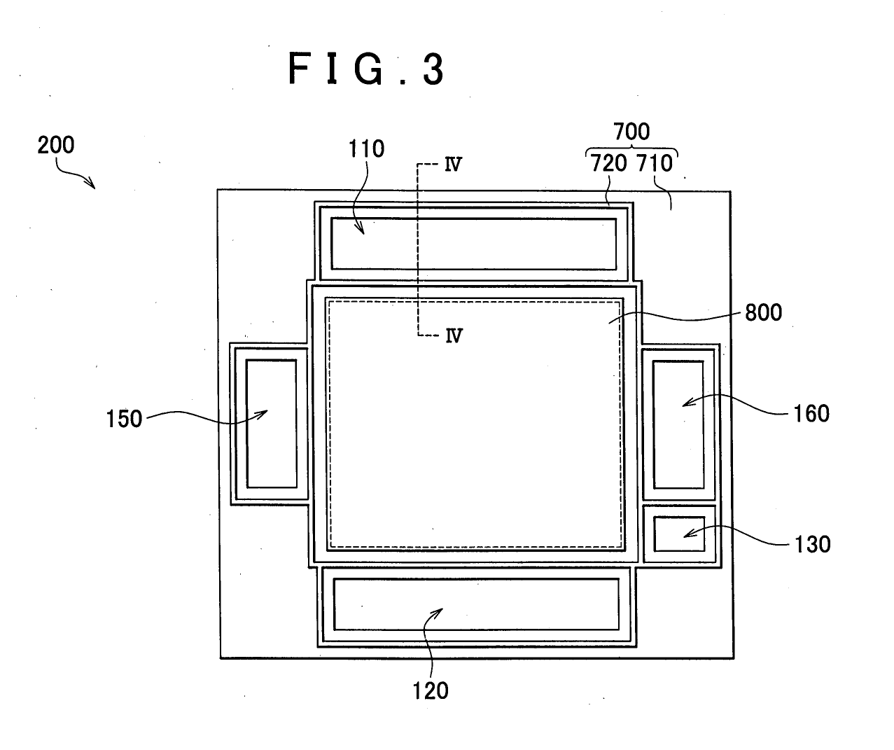

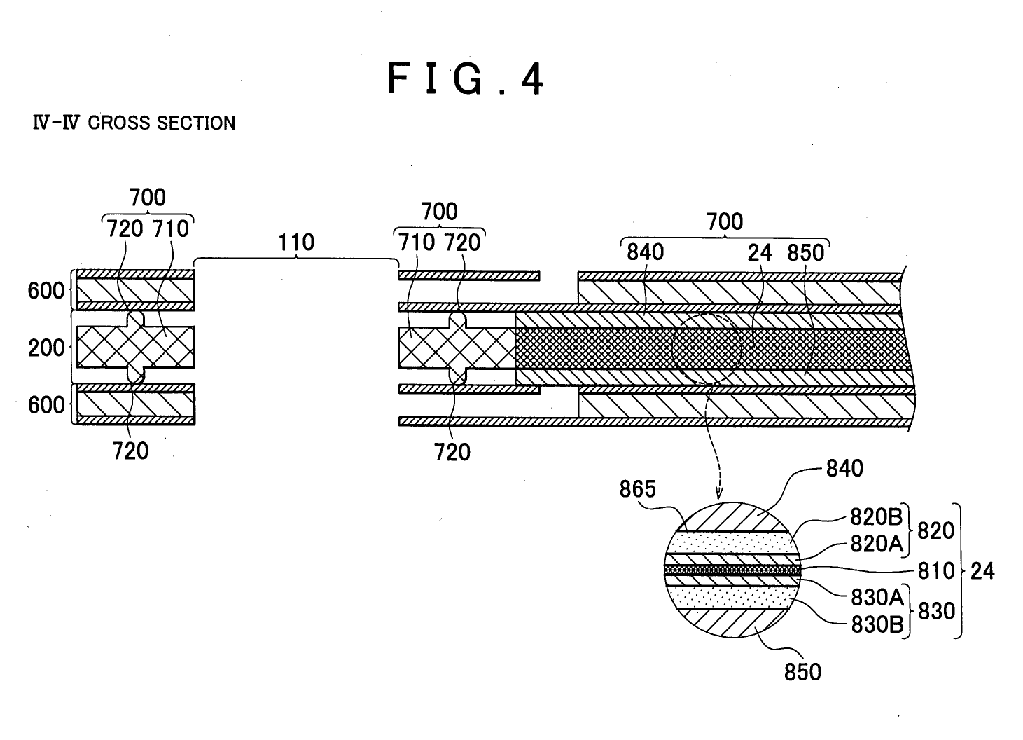

Hereinafter, the seal-integrated power generation assemblies 200 will be described. FIG. 3 shows the structure of each seal-integrated power generation assembly 200 as viewed from the right side of FIG. 2. FIG. 4 shows a cross section taken along line IV-IV in FIG. 3. FIG. 4 shows one seal-integrated power generation assembly 200 and two separators 600 provided on both sides of the seal-integrated power generation assembly 200.

Referring to FIG. 2 to FIG. 4, each seal-integrated power generation assembly 200 is constituted of a stack module 800 and the sealer 700. As shown in FIG. 4, the stack module 800 is constituted of an MEA 24, an anode-side porous portion 840, and a cathode-side porous portion 850.

The MEA 24 is constituted of an electrolyte membrane 810, an anode 820, and a cathode 830. The electrolyte membrane 810 is an ion-exchange membrane made of fluorine resin material (e.g., Nafion (registered trademark)) and exhibiting a high ion-conductivity in wet condition. Detail on the electrolyte membrane 810 will be described later. The anode 820 is constituted of a catalyst layer 820A provided on one side of the electrolyte membrane 810 and an anode-side diffusion layer 820B provided on the outer side of the catalyst layer 820A. The cathode 830 is constituted of a catalyst layer 830A provided on the other side of the electrolyte membrane 810 and an cathode-side diffusion layer 830B provided on the outer side of the catalyst layer 830A. The catalyst layers 820A and 830A are formed of, for example, electrolytes and catalyst carriers on which catalysts (e.g., platinum) are supported (platinum-carrying carbons). The anode-side diffusion layer 820B and the cathode-side diffusion layer 830B are formed of, for example, carbon cloths formed by weaving threads made of carbon fibers, carbon papers, or carbon felts. Each MEA 24 has a rectangular shape.

The anode-side porous portion 840 and the cathode-side porous portion 850 are made of a porous material having a gas diffusivity and a conductivity (e.g., porous metal). For example, expanded metal, perforated metal, meshes, felts, etc., are used. Further, the anode-side porous portion 840 and the cathode-side porous portion 850 contact power generation regions DA of the separators 600, which will be described later, when the seal-integrated power generation assemblies 200 and the separators 600 are stacked to form the fuel cell unit 100. Further, the anode-side porous portion 840 serves as a fuel-gas supply passage for supplying fuel gas to the anode 820 as will be described later, while the cathode-side porous portion 850 serves as an oxidizing-gas supply passage for supplying oxidizing gas to the cathode 830 as will be described later.

The sealer 700 is provided at the outer periphery of the stack module 800 along the plane thereof (will be referred to as “planar direction”). The sealer 700 is manufactured by injection molding using a mold. Mode specifically, the sealer 700 is manufactured by setting the stack module 800 on a mold such that the outer peripheral end face of the stack module 800 faces a cavity of the mold and then injecting material into the cavity. As such, the sealer 700 is formed so as to surround the outer periphery of the stack module 800 air-tightly with no gaps therebetween. The sealer 700 is made of a material that is gas-impermeable and elastic and exhibits a high thermal resistance within the operation temperature range of the fuel cell unit, such as rubber and elastomer. More, specifically, silicon rubber, butyl rubber, acrylic rubber, natural rubber, fluorine rubber, ethylene propylene rubber, styrene elastomer, fluorine elastomer, etc. may be used as the material of the sealer 700.

Referring to FIG. 2 to FIG. 4, the sealer 700 has a support portion 710 and ribs 720 provided on the both sides of the support portion 710 and forming a seal line. Referring to FIG. 3, through holes (manifold holes) are formed in the support portion 710. These through holes form the manifolds 110 to 150, respectively (Refer to FIG. 1). When the seal-integrated power generation assemblies 200 and the separators 600 are stacked, each rib 720 sticks to the adjacent separator 600 and thus seals between the seal-integrated power generation assembly 200 and the separator 600, preventing leaks of the reaction gas and the coolant. The rib 720 forms a seal line surrounding the stack module 800 entirely and seal lines surrounding the respective manifold holes entirely as shown in FIG. 3.

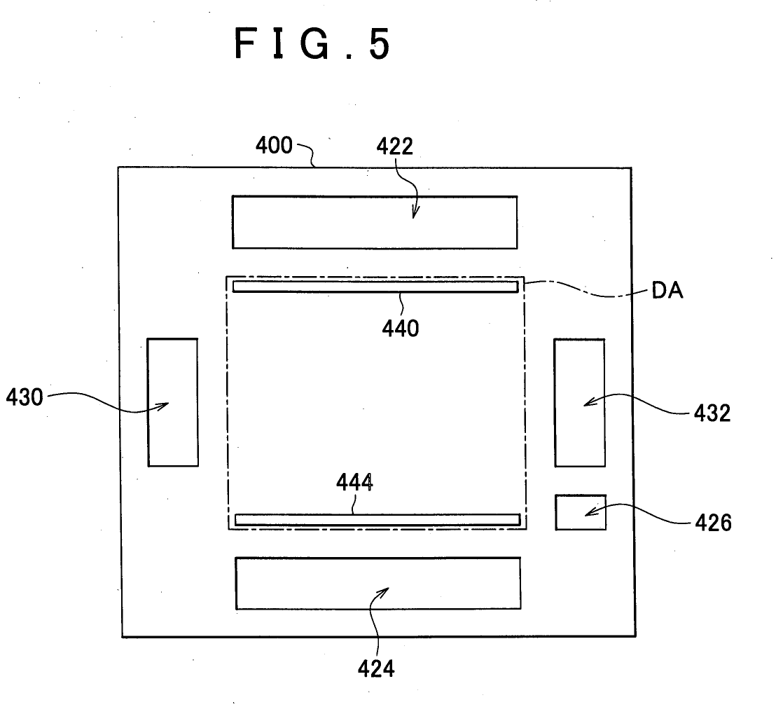

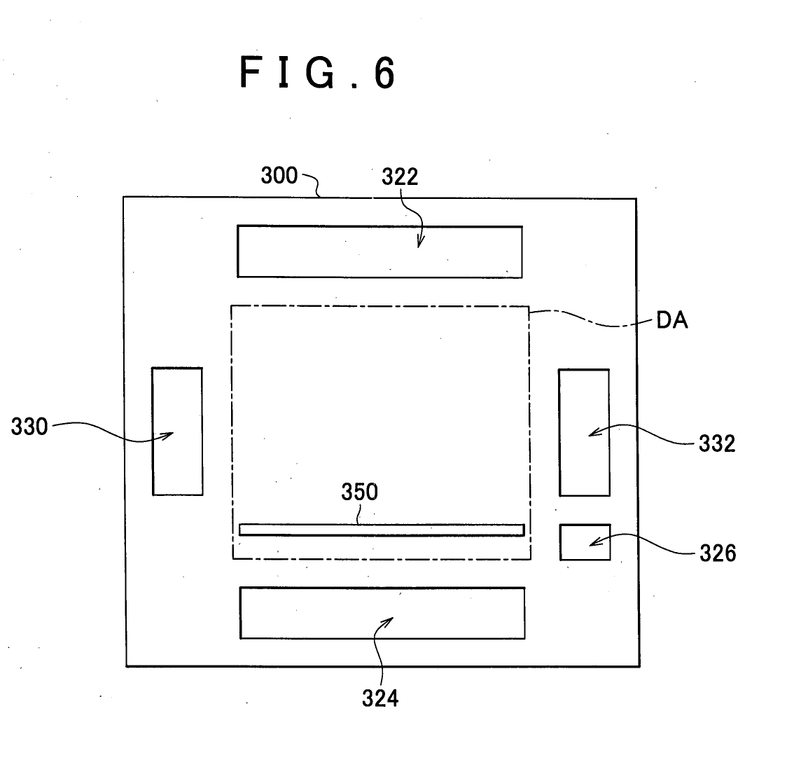

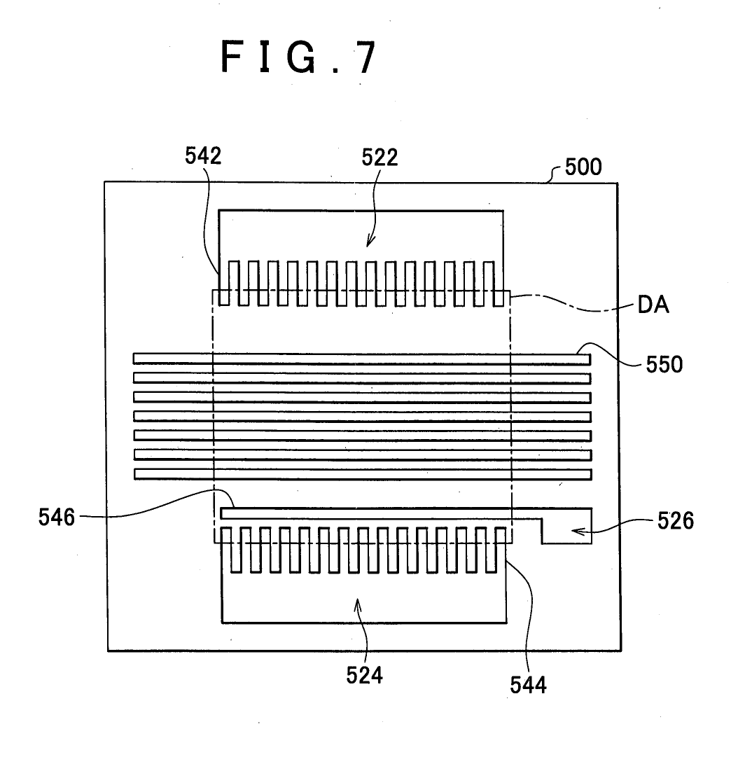

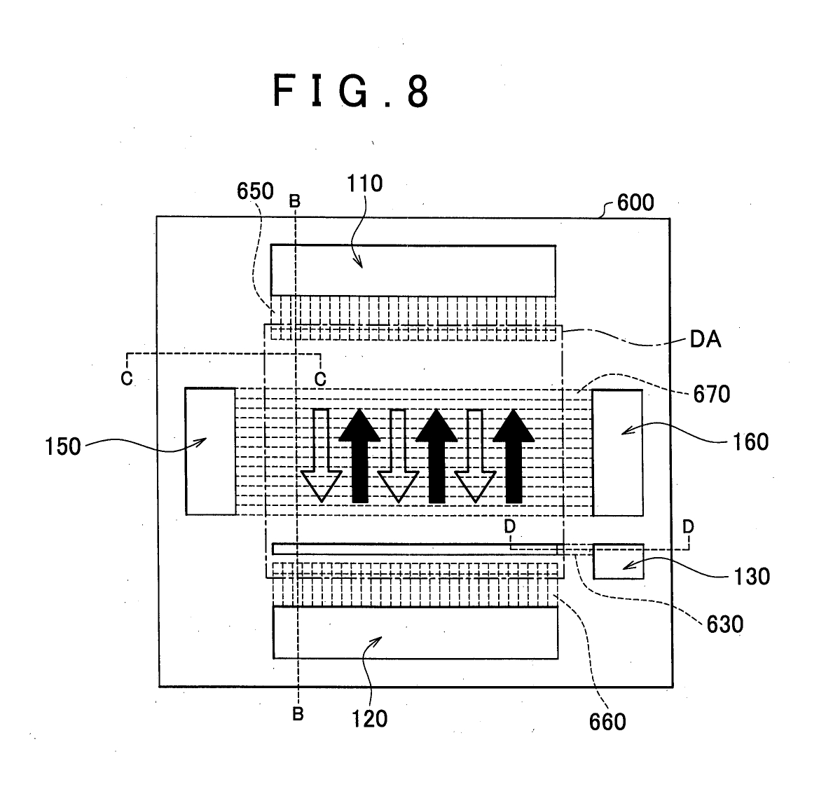

Next, the structure of the separators 600 will be described. FIG. 5 shows the shape of a cathode plate 400 of the separator 600. FIG. 6 shows the shape of an anode plate 300 of the separator 600. FIG. 7 shows the shape of an intermediate plate 500 of the separator 600. FIG. 8 is an elevation view of the separators 600. Each separator 600 is constituted of the cathode plate 400, the anode plate 300, and the intermediate plate 500 shown in FIG. 5 to FIG. 7, respectively. FIG. 5 to FIG. 8 show views of the cathode plate 400, the anode plate 300, the intermediate plate 500, and the separator 600 seen from the right side in FIG. 2. The black and white arrows in FIG. 8 will be later explained.

Indicated by broken lines at the centers of the plates 300, 400, and 500 and the separator 600 in FIG. 5 to FIG. 8 is a region DA that faces the MEA 24 of the stack module 800 of the seal-integrated power generation assembly 200 when the separators 600 and the seal-integrated power generation assemblies 200 are stacked to form the fuel cell unit 100. Because the MEA 24 is where power generation is performed, the region DA will hereinafter be referred to as “power generation region DA”. Since the MEA 24 is rectangular, the power generation region DA is rectangular naturally. The plates 300 to 500 are made of stainless steel.

Referring to FIG. 5, the cathode plate 400 has five manifold openings 422 to 432, an oxidizing-gas supply slit 440, and an oxidizing-gas discharge slit 444. The manifold openings 422 to 432 are through holes forming the aforementioned manifolds in the fuel cell unit 100, respectively. The manifold openings 422 to 432 are arranged on the respective outer fringes of the power generation region DA. The oxidizing-gas supply slit 440 is an oblong opening having a substantially rectangular cross section and formed in the power generation region DA along the upper side of the power generation region DA. Likewise, the oxidizing-gas discharge slit 444 is an oblong opening having a substantially rectangular cross section and formed in the power generation region DA along the lower side of the power generation region DA.

Referring to FIG. 6, like the cathode plate 400, the anode plate 300 has five manifold openings 322 to 332 and a fuel-gas supply slit 350. The manifold openings 322 to 332 are through holes forming the above-described manifolds in the fuel cell unit 100, respectively. The manifold openings 322 to 332 are arranged on the respective outer fringes of the power generation region DA. The fuel-gas supply slit 350 is formed in the power generation region DA along the right side of the power generation region DA at such a position that, when the separator 600 is assembled, the fuel-gas supply slit 350 does not overlap the oxidizing-gas discharge slit 444 of the cathode plate 400.

Referring to FIG. 7, the intermediate plate 500 has three manifold openings 522 to 526 for supplying and discharging the reaction gases (oxidizing gas and fuel gas), a plurality of oxidizing-gas supply passage openings 542, a plurality of oxidizing-gas discharge passage openings 544, and a single fuel-gas supply passage opening 546. Further, the intermediate plate 500 has a plurality of coolant passage openings 550. The manifold openings 522 to 526 form the above-described manifolds in the fuel cell stack 100, respectively. The manifold openings 522 to 526 are arranged on the respective outer fringes of the power generation region DA. Each coolant passage opening 550 is oblong penetrating the power generation region DA in the horizontal direction of FIG. 7, and the both ends of the coolant passage opening 550 are located outside of the power generation region DA.

Referring to FIG. 7, in the intermediate plate 500, the oxidizing-gas supply passage openings 542 communicate, on one side, with the manifold opening 522. The end portions of the oxidizing-gas supply passage openings 542 on the other side overlap the oxidizing-gas supply slit 440 of the cathode plate 400 when the anode plate 300, the cathode plate 400, and the intermediate plate 500 are joined together to form the separator 600. Likewise, the oxidizing-gas discharge passage openings 544 communicate, on one side, with the manifold opening 524. The end portions of the oxidizing-gas discharge passage openings 544 on the other side overlap the oxidizing-gas supply slit 444 of the cathode plate 400 when the anode plate 300, the cathode plate 400, and the intermediate plate 500 are joined together to form the separator 600.

Referring to FIG. 7, in the intermediate plate 500, one end of the fuel-gas supply passage opening 546 communicates with the manifold opening 526. The fuel-gas supply passage opening 546 extends along the lower side of the power generation region DA at a position not overlapping the oxidizing-gas discharge passage openings 544, and the end of the fuel-gas supply passage opening 546 on the same side is located near the left side of the power generation region DA. The portion of the fuel-gas supply passage opening 546 that is located in the power generation region DA overlaps the fuel-gas supply slit 350 of the anode plate 300 when the anode plate 300, the cathode plate 400, and the intermediate plate 500 are joined together to form the separator 600.

Referring to FIG. 8, each separator 600 is assembled by joining the anode plate 300, the cathode plate 400, and the intermediate plate 500 such that the intermediate plate 500 is sandwiched between the anode plate 300 and the cathode plate 400 and then punching through the exposed portions at the regions corresponding to the coolant supply manifold 150 and to the coolant discharge manifold 160 of the intermediate plate 500, respectively. As such, the separators 600 each having the five manifolds 110 to 160, which are the through holes shown in FIG. 8, a plurality of oxidizing-gas supply passages 650, a plurality of oxidizing-gas discharge passages 660, a fuel-gas supply passage 630, and a plurality of coolant passages 670 are manufactured.

As shown in FIG. 8, each oxidizing-gas supply passage 650 is defined by the oxidizing-gas supply slit 440 of the cathode plate 400 and the corresponding one of the oxidizing-gas supply passage openings 542 of the intermediate plate 500. Each oxidizing-gas supply passage 650 is an internal passage extending in the separator 600. One end of the oxidizing-gas supply passage 650 communicates with the oxidizing-gas supply manifold 110 and the other end is at the surface of the separator 600 (the cathode plate 400) on the cathode 830 side, creating an opening in said surface. Further, as shown in FIG. 8, each oxidizing-gas discharge passage 660 is defined by the oxidizing-gas discharge slit 444 of the cathode plate 400 and the corresponding one of the oxidizing-gas discharge passage openings 544 of the intermediate plate 500. Each oxidizing-gas discharge passage 660 is an internal passage extending in the separator 600. One end of the oxidizing-gas discharge passage 660 communicates with the oxidizing-gas discharge manifold 120 and the other end is at the surface of the separator 600 (the cathode plate 400) on the cathode 830 side, creating an opening in said surface.

Referring to FIG. 8, the fuel-gas supply passage 630 is defined by the fuel-gas supply slit 350 of the anode plate 300 and the fuel-gas supply passage opening 546 of the intermediate plate 500. The fuel-gas supply passage 630 is an internal passage communicating at one end with the fuel-gas supply manifold 130 and leading at the other end to the surface of the separator 600 (the anode plate 300) on the anode 820 side, creating an opening in said surface. Referring to FIG. 7, the coolant passages 670 are defined by the coolant passage openings 550 of the intermediate plate 500. Each coolant passage 670 communicates at one end with the coolant supply manifold 150 and at other end with the coolant discharge manifold 160.

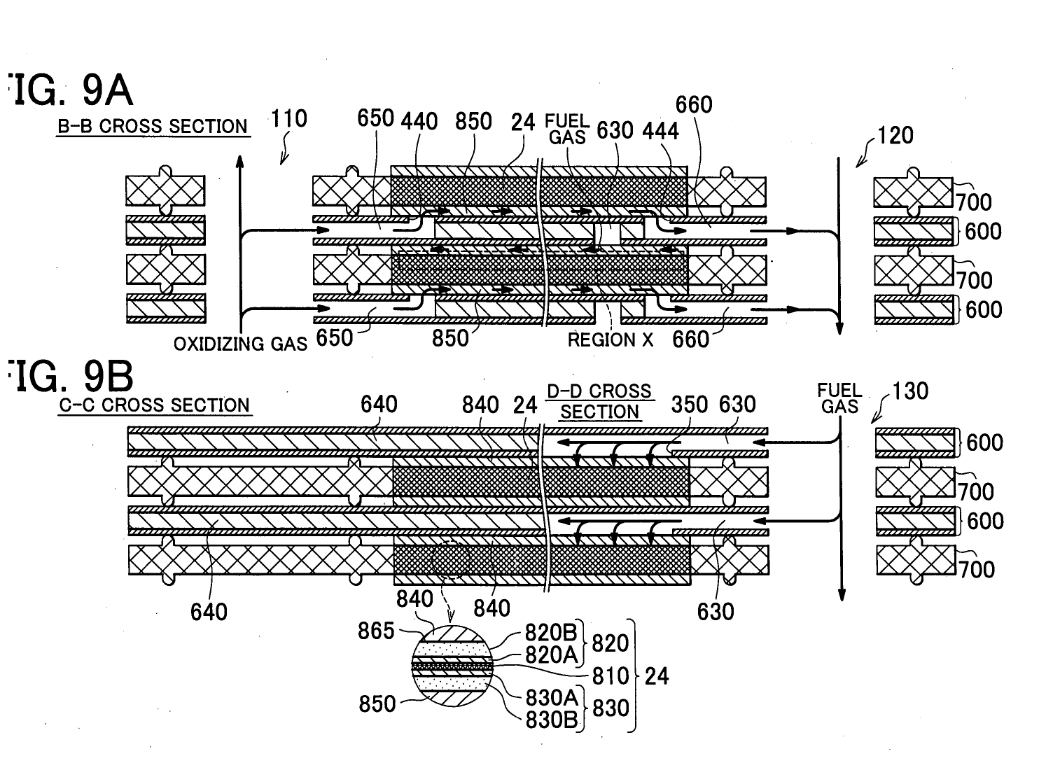

Next, the operation of the fuel cell unit 100 will be described. FIG. 9A and FIG. 9B show the reaction gas flows in the fuel cell unit 100 of the example embodiment. For the sake of clarity, FIG. 9A and FIG. 9B only show two seal-integrated power generation assemblies 200 and two separators 600 which are alternately stacked on each other. FIG. 9A shows a cross section taken along the line B-B in FIG. 8. The right side of FIG. 9B shows a cross section taken along the line D-D in FIG. 8 while the left side shows a cross section taken along the line C-C in FIG. 8. The arrows in FIG. 9A and FIG. 9B represent the reaction gas flows.

The fuel cell unit 100 generates power as oxidizing gas is supplied to the oxidizing-gas supply manifold 110 and fuel gas is supplied to the fuel-gas supply manifold 130. During the power generation of the fuel cell unit 100, the heat generated by the power generation raises the temperature of the fuel cell unit 100, and therefore coolant is supplied to the coolant supply manifold 150 to suppress the increase in the temperature of the fuel cell unit 100. The coolant supplied to the coolant supply manifold 150 is delivered to the coolant passages 670. The coolant thus supplied to each coolant passage 670 flows from one end to the other end of the coolant passage 670 while causing heat exchange and then it is discharged to the coolant discharge manifold 160.

As indicated by the arrows in FIG. 9A, the oxidizing gas supplied to the oxidizing-gas supply manifold 110 flows through the oxidizing-gas supply passage 650 and then enters the cathode-side porous portion 850 via the oxidizing-gas supply slit 440 (FIG. 5). After entering the cathode-side porous portion 850, the oxidizing gas flows on through the inside of the cathode-side porous portion 850, which serves as an oxidizing-gas supply passage, from the upper side to the lower side as indicated by the white arrows in FIG. 8. That is, in this case, the upper side of FIG. 8 corresponds to the upstream side and the lower side of FIG. 8 corresponds to the downstream side. Then, the oxidizing gas enters the oxidizing-gas discharge passage 660 via the oxidizing-gas discharge slit 444 (FIG. 5), and then it is discharged to the oxidizing-gas discharge manifold 120. A portion of the oxidizing gas flowing through the inside of the cathode-side porous portion 850 diffuses throughout the entire portion of the cathode-side diffusion layer 830B abutting on the cathode-side porous portion 850 and then it is used for cathode reactions (e.g., 2H⁺+2e⁻+(½)O₂→H₂O).

As indicated by the arrows in FIG. 9B, the fuel gas supplied to the fuel-gas supply manifold 130 flows to the fuel-gas supply passage 630 and then enters the anode-side porous portion 840 via the fuel-gas supply slit 350 (FIG. 6). After entering the anode-side porous portion 840, the fuel gas flows on through the inside of the anode-side porous portion 840, which serves an a fuel-gas supply passage, from the lower side to the upper side as indicated by the black arrows in FIG. 8. That is, in this case, the upper side of FIG. 8 corresponds to the downstream side and the lower side of FIG. 8 corresponds to one example of the upstream side. The fuel gas flowing through the inside of the anode-side porous portion 840 diffuses throughout the entire portion of the anode-side diffusion layer 820B abutting on the anode-side porous portion 840 and then it is used for anode reactions (e.g., H₂→2H⁺+2e⁻). In the following, “upstream” and “downstream” represent the upstream side (direction) and the downstream side (direction) of the flow direction of fuel gas unless specified otherwise. As mentioned above, the fuel cell unit 100 of the first example embodiment employs an anode dead-end structure, and therefore the fuel gas supplied to the anode-side porous portion 840 is basically consumed at the anode 820.

In the anode-side porous portion 840 (fuel-gas supply passage) of the fuel cell unit 100, the fuel gas flows from the upstream side to the downstream side, and this fuel-gas flow inhibits the leak gas from the cathode 830 from diffusing to the upstream side of the anode-side porous portion 840. As a result, the leak gas from the cathode 830 stagnates in the downstream side of the anode-side porous portion 840.

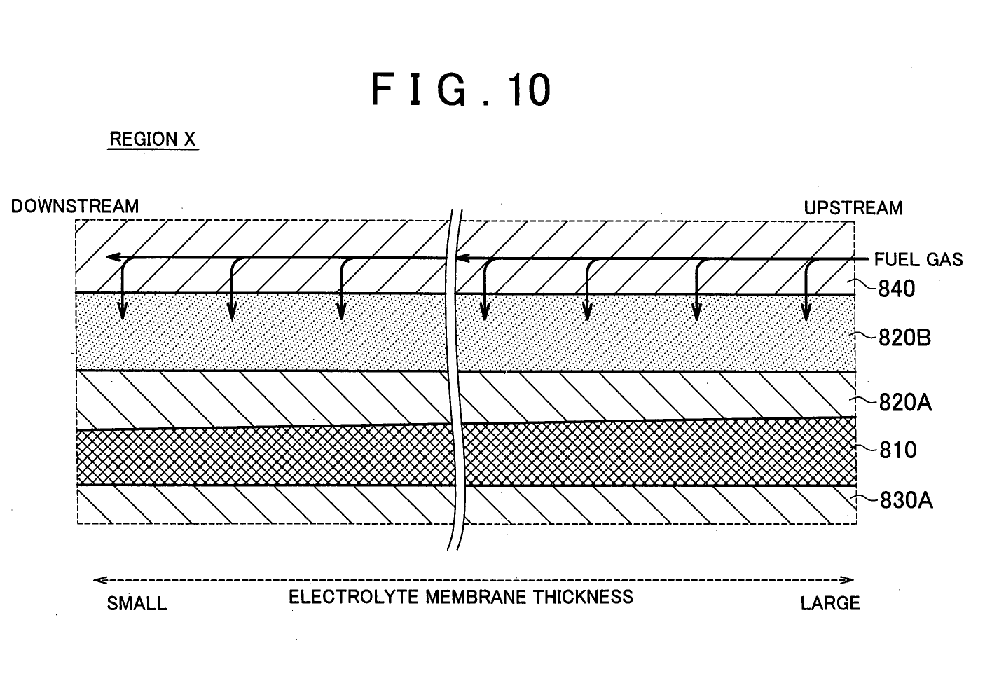

FIG. 10 is an enlarged view of the region X in FIG. 9A. Referring to FIG. 10, the fuel gas flows from the right side to the left side, and thus the right side corresponds to the upstream side and the left side corresponds to the downstream side, and the arrows represent the flows of the fuel gas. Referring to FIG. 10, the thickness of the electrolyte membrane 810 gradually increases from the downstream side to the upstream side. In other words, the thickness of the electrolyte membrane 810 gradually decreases from the upstream side to the downstream side. Thus, gas flows more easily through the downstream side of the electrolyte membrane 810 than through the upstream side in the direction of the thickness of the electrolyte membrane 810 (will be referred to as “thickness direction”). In other words, the gas permeability of the electrolyte membrane 810 is higher at the downstream side than at the upstream side. According to this structure, the leak gas does not stagnate in the downstream region of the anode-side porous portion 840 but it returns to the cathode 830 via the electrolyte membrane 810 (the downstream side of the electrolyte membrane 810). Thus, the leak gas from the cathode 830 does, not stagnate in the anode-side porous portion 840 (fuel-gas supply passage).

In the first example embodiment, the electrolyte membrane 810 may be regarded as one example of “electrolyte membrane” of the invention, and the anode 820 may be regarded as one example of “anode” of the invention, and the anode-side porous portion 840 may be regarded as one example of “fuel-gas passage portion” of the invention.

Hereinafter, the second example embodiment of the invention will be described. A fuel cell unit 100A of the second example embodiment has substantially the same structure as that of the fuel cell unit 100 of the first example embodiment except that electrolyte membranes 810A in the fuel cell unit 100A are different from the electrolyte membranes 810 in the fuel cell unit 100.

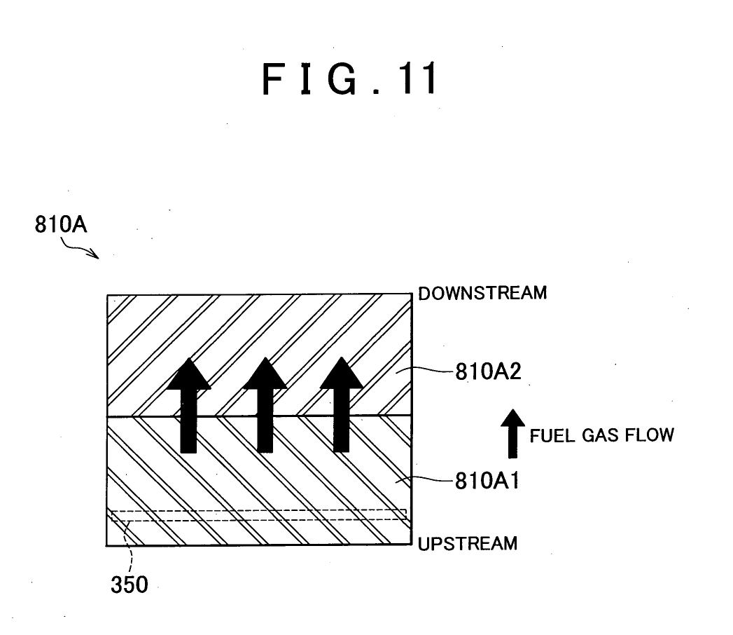

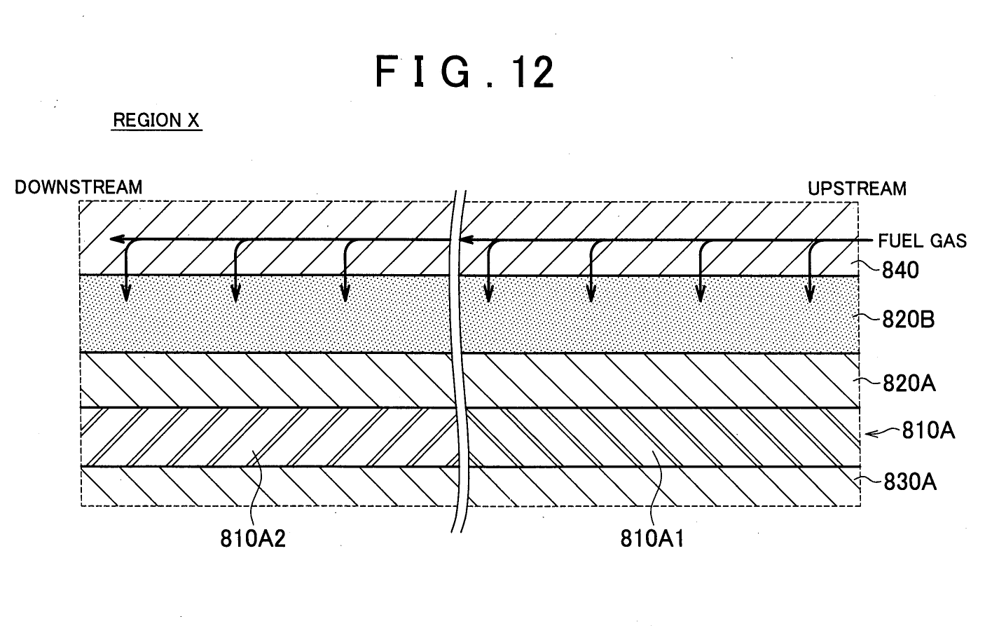

FIG. 11 shows the electrolyte membranes 810A in the fuel cell unit 100A of the second example embodiment. FIG. 12 schematically shows a cross section of each electrolyte membrane 810A. FIG. 12 corresponds to FIG. 10 of the fuel cell unit 100 of the first example embodiment. The structural elements of the fuel cell unit 100A identical to those of the fuel cell unit 100 are denoted by the same numerals and their descriptions are omitted. As shown in FIG. 12, the thickness of each electrolyte membrane 810A is uniform. Referring to FIG. 11 and FIG. 12, the upstream side and the downstream side of each electrolyte membrane 810A are made of different materials. More specifically, the upstream side of the electrolyte membrane 810A is made of hydrocarbon resin (this portion will be referred to as “hydrocarbon electrolyte membrane 810A1”) and the downstream side of the electrolyte membrane 810 is made of fluorine resin (this portion will be referred to as “fluorine electrolyte membrane 810A2). In general, the gas permeability of fluorine resin is higher than the gas permeability of hydrocarbon resin.

As such, in the fuel cell unit 100A of the second example embodiment, the electrolyte membrane 810A is constituted of the hydrocarbon electrolyte membrane 810A1 at the upstream side and the fluorine electrolyte membrane 810A2 at the downstream side. As such, the gas permeability of the electrolyte membrane 810A in its thickness direction is higher at the downstream side than at the upstream side. According to this structure, the leak gas does not stagnate in the downstream region of the anode-side porous portion 840 (fuel-gas supply passage) but it returns to the cathode 830 via the electrolyte membrane 810A (the downstream side of the electrolyte membrane 810A). Thus, the leak gas from the cathode 830 does not stagnate in the anode-side porous portion 840 (fuel-gas supply passage).

In the second example embodiment, the electrolyte membrane 810A may be regarded as one example of “electrolyte membrane” of the invention, the hydrocarbon electrolyte membrane 810A1 may be regarded as one example of “hydrocarbon electrolyte membrane” of the invention, and the fluorine electrolyte membrane 810A2 may be regarded as one example of “fluorine resin membrane” of the invention.

Hereinafter, the third example embodiment of the invention will be described. A fuel cell unit 100B of the third example embodiment has substantially the same structure as that of the fuel cell unit 100 of the first example embodiment except that electrolyte membranes 810B in the fuel cell unit 100B are different from the electrolyte membrane 810 of the fuel cell unit 100 and that anodes 820α in the fuel cell unit 100B are different from the anodes 820 in the fuel cell unit 100.

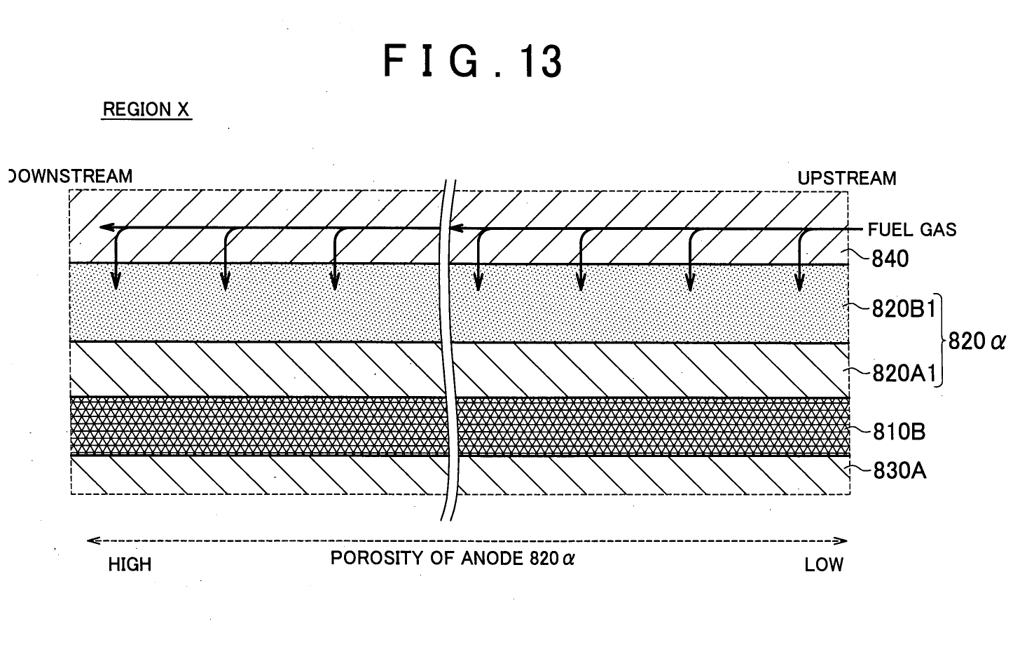

FIG. 13 schematically shows cross sections of the electrolyte membrane 810B and the anode 820α of the fuel cell unit 100B of the third example embodiment. FIG. 13 corresponds to FIG. 10 showing the fuel cell unit 100 of the first example embodiment. The structural elements of the fuel cell unit 100B identical to those of the fuel cell unit 100 are denoted by the same numerals and their descriptions are omitted. As shown in FIG. 13, the thickness of each electrolyte membrane 810B is uniform unlike the electrolyte membranes 810 of the fuel cell unit 100 of the first example embodiment. Referring to FIG. 13, the porosity of the anode 820α (the anode-side diffusion layer 820B1 and the catalyst layer 820A1) gradually decreases from the downstream side to the upstream side. In other words, the porosity of the anode 820α gradually increases from the upstream side to the downstream side.

As such, in the fuel cell unit 100B of the third example embodiment, the porosity of the anode 820α is higher at the downstream side than at the upstream side. Therefore, the gas permeability of the anode 820α in its thickness direction is higher at the downstream side than at the upstream side. According to this structure, the leak gas does not stagnate in the downstream region of the anode-side porous portion 840 (fuel-gas supply passage) but it returns to the cathode 830 via the anode 820α (the downstream side of the anode 820α). Thus, the leak gas from the cathode 830 does not stagnate in the anode-side porous portion 840 (fuel-gas supply passage).

In the third example embodiment, the electrolyte membrane 810B may be regarded as one example of “electrolyte membrane” of the invention, and the anode 820α may be regarded, as one example of “anode” of the invention.

Hereinafter, the fourth example embodiment of the invention will be described. A fuel cell unit 100C of the fourth example embodiment has substantially the same structure as that of the fuel cell unit 100 of the first example embodiment except that electrolyte membranes 810C in the fuel cell unit 100C are different from the electrolyte membranes 810 in the fuel cell unit 100 and that the fuel cell unit 100C includes conductive sheets 860.

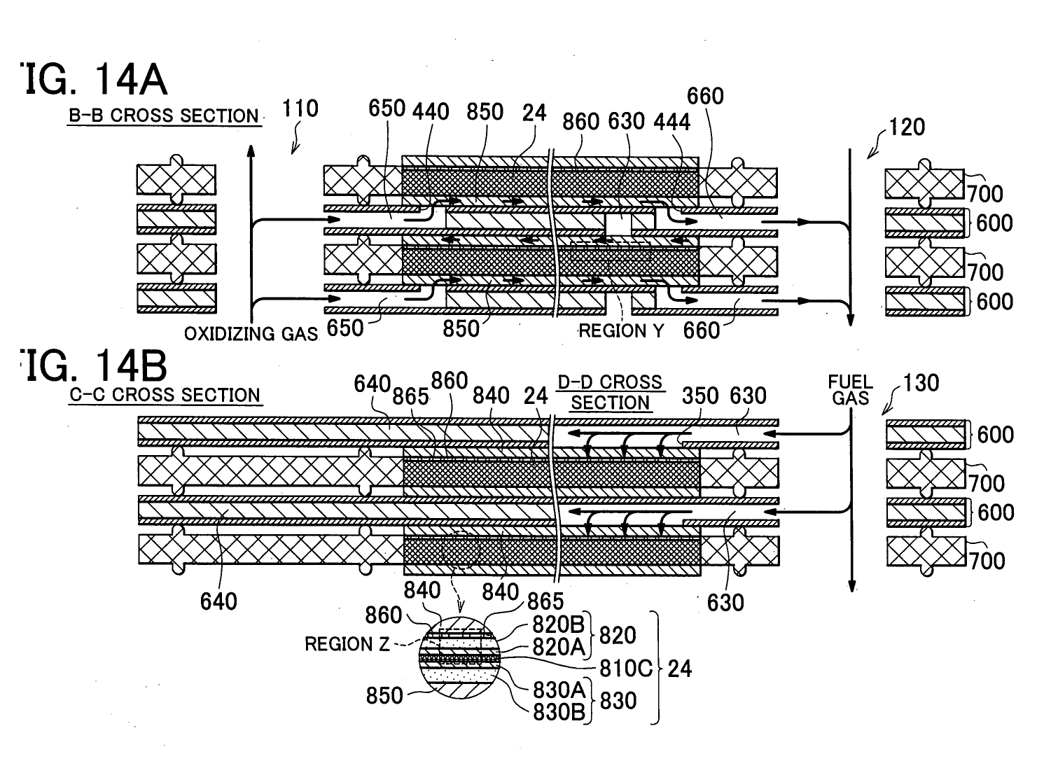

FIG. 14A and FIG. 14B schematically show cross sections of the fuel cell unit 100C. FIG. 14A and FIG. 14B correspond to FIG. 9A and FIG. 9B of the fuel cell unit 100 of the first example embodiment. The structural elements of the fuel cell unit 100C identical to those of the fuel cell unit 100 are denoted by the same numerals and their descriptions are omitted. Each conductive sheet 860 is provided between the anode 820 (the anode-side diffusion layer 820B) and the anode-side porous portion 840 (fuel-gas supply passage) as shown in FIG. 14.

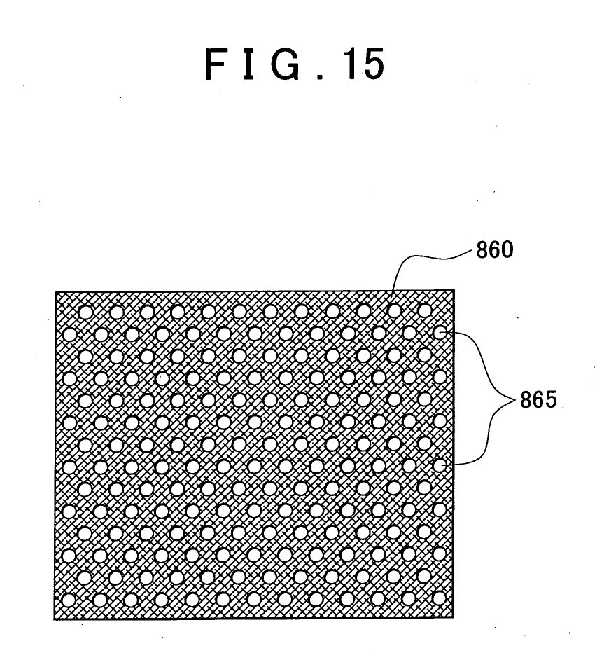

FIG. 15 is an elevation view of the conductive sheet 860 as seen from the upper side of FIG. 14. Referring to FIG. 15, each conductive sheet 860 is formed in a sheet-like shape (a thin membrane shape), and a number of through holes 865 are dispersedly formed in the conductive sheet 860. Each through hole 865 is generally circular and has a common aperture diameter (that is, each through hole 865 has common shape and size). The through holes 865 are arranged in the surface of the conductive sheet in a staggered pattern. Each conductive sheet 860 is made of gold and is joined to one side of the anode-side porous portion 840 by thermal-compression bonding, soldering, welding, or the like. Note that the through holes 865 of each conductive sheet 860 may be arranged in a grid pattern.

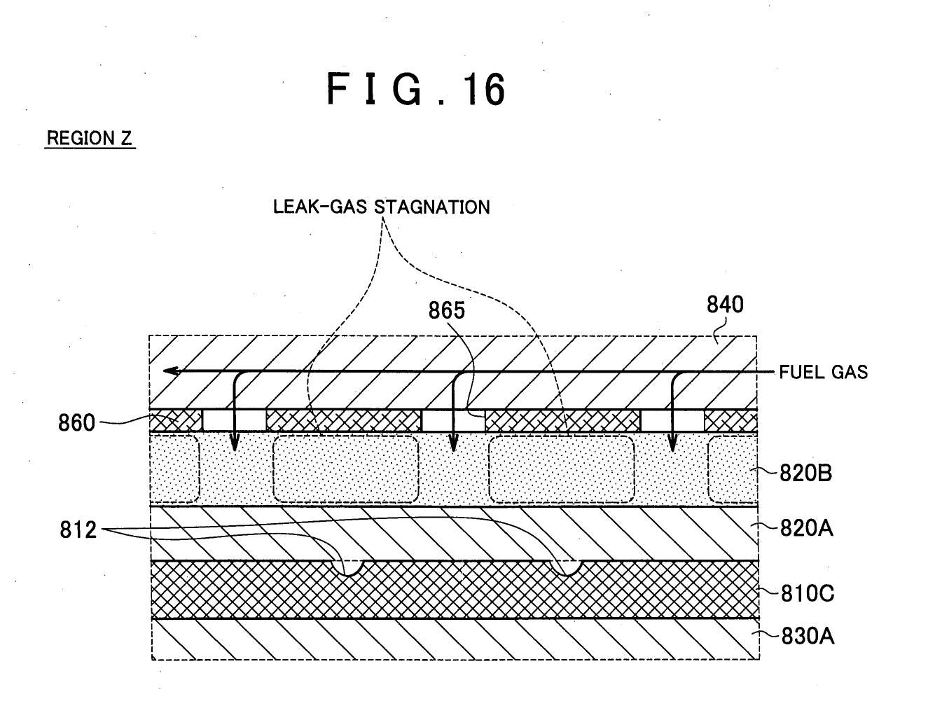

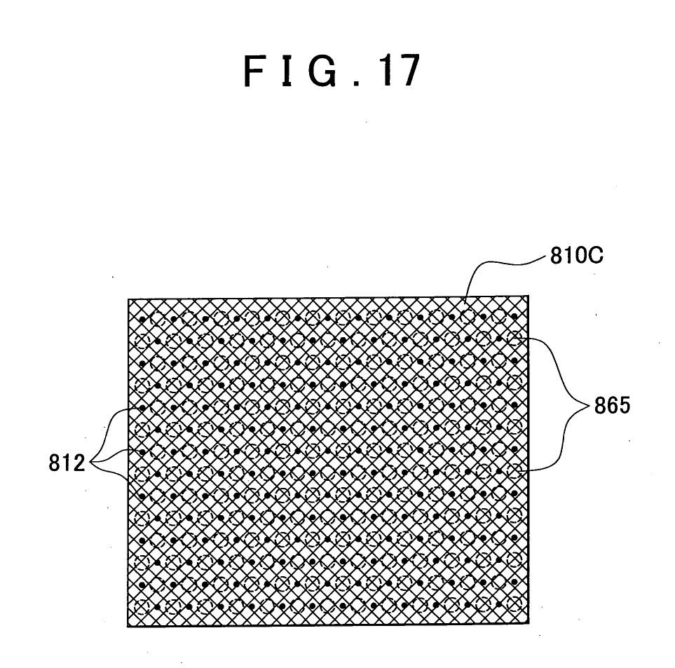

FIG. 16 is an enlarged view of the region Z in FIG. 14. FIG. 17 shows the electrolyte membrane 810C as seen from the upper side of the FIG. 14. FIG. 17 shows the positions corresponding to the through holes 865 of the conductive sheet 860. As shown in FIG. 16 and FIG. 17, a number of concave portions 812 are dispersedly formed on the surface of each electrolyte membrane 810 of the fuel cell unit 100C. Further, referring to FIG. 16, the thickness of the electrolyte membrane 810C is uniform except at the concave portions 812. Each concave portion 812 is generally circular and has a common aperture diameter (that is, each concave portion 812 has common shape and size). The concave portions 812 are arranged in a staggered pattern in the surface of the electrolyte membrane 810C. The thickness of the electrolyte membrane 810C is small and therefore the gas permeability is high at each concave portion 812 as compared to other portions.

Further, the through holes 865 of the conductive sheet 860 and the concave portions 812 of the electrolyte membrane 810C are arranged so as not to overlap each other when the stack module 800 is viewed in the stacking direction (thickness direction) as shown in FIG. 16 and FIG. 17. In other words, the through holes 865 of the conductive sheet 860 and the concave portions 812 of the electrolyte membrane 810C are arranged such that each concave portion 812 is located between two through holes 865 when viewed in the stacking direction.

Referring to FIG. 16, the fuel gas, after entering the anode-side porous portion 840, flows into each through hole 865 in the thickness direction of the anode 820 (the anode-side diffusion layer 820B), which is the stacking direction, and then enters the anode-side diffusion layer 820B and disperses throughout the entire portion of the anode-side diffusion layer 820B, whereby the fuel gas is supplied to the catalyst layer 820A. According to this structure, that is, the fuel gas supplied to the anode-side porous portion 840 can be dispersedly supplied to the anode 820 and thus power generation can be performed using the entire portion of the anode 820 (the catalyst layer 820A).

According to the fuel cell unit 100C of the fourth example embodiment, as described above, the conductive sheet 860 provided between the anode 820 (the anode-side diffusion layer 820B) and the anode-side porous portion 840 of the stack module 800 inhibits leak gas from entering the anode-side porous portion 840 (fuel-gas supply passage) from the anode-side diffusion layer 820B, prevents leak-gas stagnation in the anode-side porous portion 840 (fuel-gas supply passage).

Meanwhile, the majority of the leak gas is blocked by the conductive sheet 860 and thus it stagnates in the anode 820. However, there is a possibility that, as the amount of the leak gas stagnating in the anode 820 exceeds a certain level, the leak gas, due to the concentration diffusion, enters the anode-side porous portion 840 (fuel-gas supply passages) against the fuel-gas flows at the through holes 865 and stagnates in the anode-side porous portion 840. In this case, as shown in FIG. 16, the leak gas tends to stagnate in the regions of the anode 820 located between the respective through holes 865 of the conductive sheet 860 as if the leak gas is pushed into said regions by the fuel gas flowing from each through hole 865 to the anode 820.

However, in the fuel cell unit 100C of the forth example embodiment, because the concave portions 812 of the electrolyte membrane 810 are arranged to be located between the respective through holes 865 when the stack module 800 is viewed in the stacking direction (Refer to FIG. 16 and FIG. 17), the leak gas does not stagnate at the through holes 865 but it returns to the cathode 830 via the concave portions 812 where the gas permeability is relatively high. Thus, the leak gas from the cathode 830 does not enter the anode-side porous portion 840 (fuel-gas supply passage) and therefore leak-gas stagnation does not occur therein.

In the fuel cell unit 100C, preferably, the pressure at which fuel gas is supplied to the fuel-gas supply passage (will be referred to as “fuel-gas supply pressure” where necessary) and the pressure at which oxidizing gas is supplied to the oxidizing-gas supply passage (will be referred to as “oxidizing-gas supply pressure” where necessary) are set such that the minimum value of the pressure of fuel gas flowing in the fuel-gas supply passage is larger than the maximum value of the partial pressure of the leak gas at the anode 820 which has leaked from the cathode 830 side through the electrolyte membrane 810C. This may be accomplished by either setting only one of the fuel-gas supply pressure and the oxidizing-gas supply pressure to a given value or setting both of them to given values. The set value of the fuel-gas supply pressure and/or the set value of the oxidizing-gas supply pressure are determined based on, for example, particular data empirically obtained.

In the fourth example embodiment, the electrolyte membrane 810C may be regarded as one example of “electrolyte membrane” of the invention, the conductive sheet 860 may be regarded as one example of “conductive sheet” of the invention, and the through holes 865 may be regarded as “through hole” of the invention.

While the invention has been described with reference to the example embodiments thereof, it is to be understood that the invention is not limited to the example embodiments. To the contrary, the invention is intended to cover various modifications and equivalent arrangements within the scope of the invention.

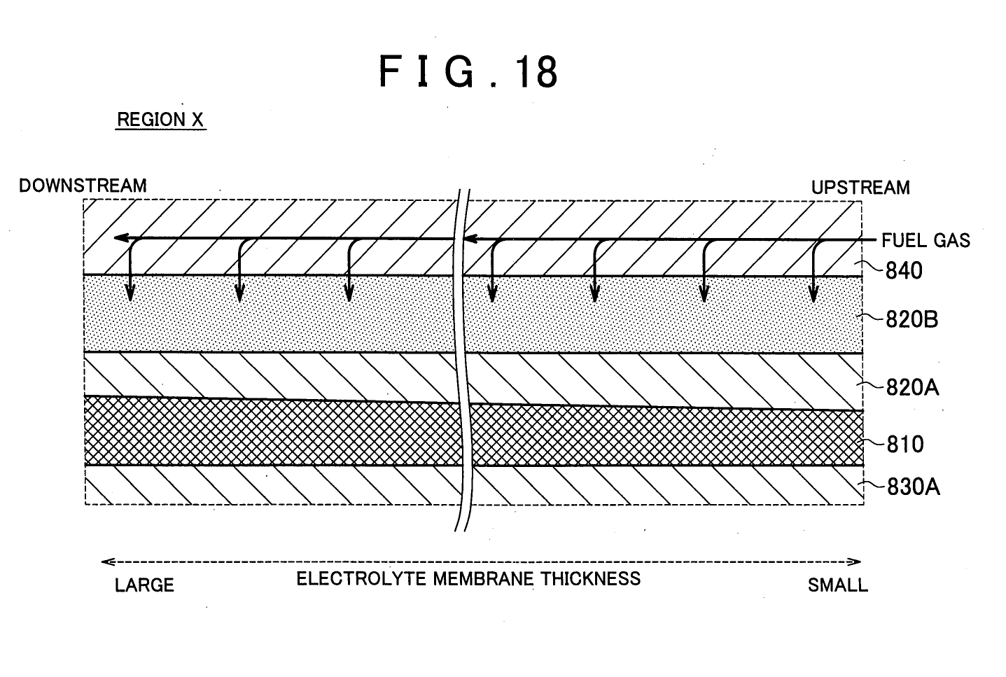

Next, a first modification example will be described. FIG. 18 schematically shows a cross section of a fuel cell unit according to the first modification example. FIG. 18 corresponds to FIG. 10 showing the fuel cell unit 100 of the first example embodiment. While each electrolyte membrane 810 in the fuel cell unit 100 is formed such that its thickness gradually decreases from the upstream side to the downstream side, the invention is not limited to this. In the fuel cell unit of the first modification example, each electrolyte membrane 810 is formed such that its thickness gradually increases from the upstream side to the downstream side. Thus, the gas permeability of the electrolyte membrane 810 in its thickness direction is lower at the downstream side than at the upstream side. This inhibits the leak gas from entering and stagnating in the downstream region of the anode-side porous portion 840 (fuel-gas supply passage), for example, in a state where the fuel cell unit is being started up or in a state where the fuel cell unit is not operating. As such, even when the fuel cell units has started power generation and thus the leak gas in the upstream side of the anode-side porous portion 840 has started flowing in the anode-side porous portion 840 toward the downstream side with the fuel gas, because leak-gas stagnation in the downstream region of the anode-side porous portion 840 was inhibited previously, the amount of the leak gas that stagnates in the downstream region of the anode-side porous portion 840 during the power generation of the fuel cell unit is not large.

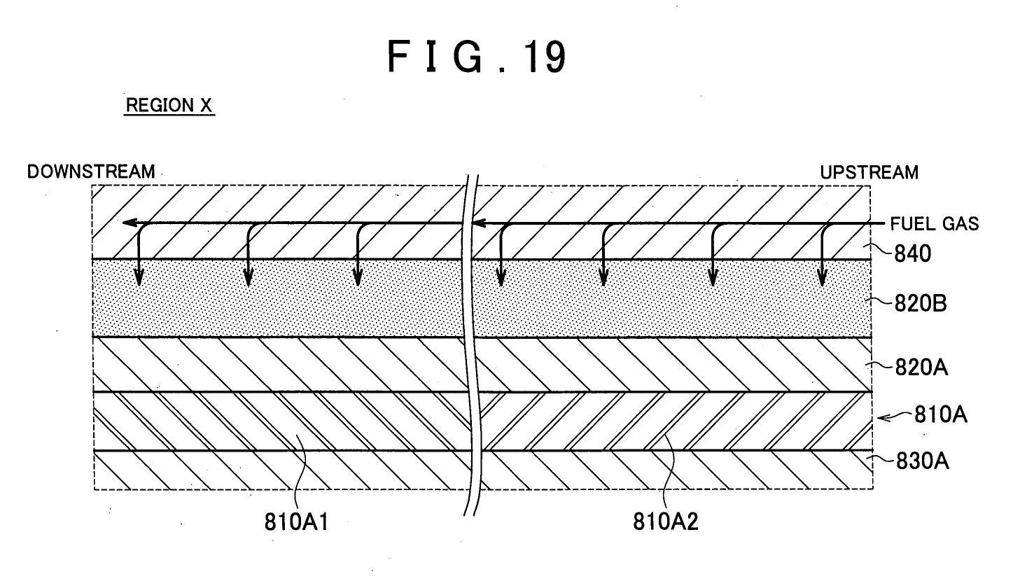

Next, the second modification example will be described. FIG. 19 schematically shows a cross section of a fuel cell unit of the second modification example. FIG. 19 corresponds to FIG. 12 showing the electrolyte membrane 810A of the second example embodiment. While each electrolyte membrane 810A in the fuel cell unit 100A of the second example embodiment is constituted of the hydrocarbon electrolyte membrane 810A1 at the upstream side and the fluorine electrolyte membrane 810A2 at the downstream side, the invention is not limited to this. In the fuel cell unit of the second modification example, as shown in FIG. 19, the upstream side of the electrolyte membrane 810A is formed by the fluorine electrolyte membrane 810A2 and the downstream side is formed by the hydrocarbon electrolyte membrane 810A1. According to this structure, the gas permeability of the electrolyte membrane 810A in its thickness direction is lower at the downstream side than at the upstream side. This inhibits the leak gas from entering and stagnating in the downstream region of the anode-side porous portion 840 (fuel-gas supply passage), for example, in a state where the fuel cell unit is being started up or in a state where the fuel cell unit is not operating. As such, even when the fuel cell units has started power generation and thus the leak gas in the upstream side of the anode-side porous portion 840 has started flowing in the anode-side porous portion 840 toward the downstream side with the fuel gas, because leak-gas stagnation in the downstream region of the anode-side porous portion 840 was inhibited previously, the amount of the leak gas that stagnates in the downstream region of the anode-side porous portion 840 during the power generation of the fuel cell unit is not large.

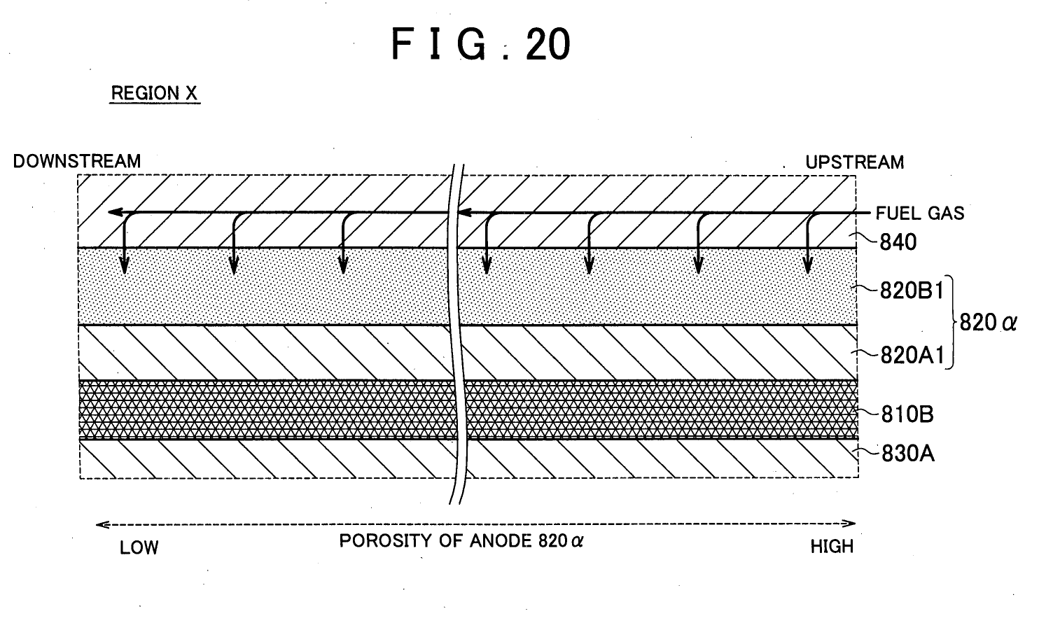

Next, the third modification example will be described. FIG. 20 schematically shows a cross section of a fuel cell unit of the third modification example. FIG. 20 corresponds to FIG. 13 showing the electrolyte membrane 810B of the third example embodiment. While the porosity of each anode 820α in the fuel cell unit 100B of the third example embodiment is higher at the downstream side than at the upstream side, the invention is not limited to this. In the fuel cell unit of the third modification example, as shown in FIG. 20, the porosity of each anode 820α is lower at the downstream side than at the upstream side. According to this structure, the gas permeability of each anode 820α in its thickness direction is lower at the downstream side than at the upstream side. This inhibits the leak gas from entering and stagnating in the downstream region of the anode-side porous portion 840 (fuel-gas supply passage), for example, in a state where the fuel cell unit is being started up or in a state where the fuel cell unit is not operating. As such, even when the fuel cell units has started power generation and thus the leak gas in the upstream side of the anode-side porous portion 840 has started flowing in the anode-side porous portion 840 toward the downstream side with the fuel gas, because leak-gas stagnation in the downstream region of the anode-side porous portion 840 was inhibited previously, the amount of the leak gas that stagnates in the downstream region of the anode-side porous portion 840 during the power generation of the fuel cell unit is not large.

In the fuel cell units of the respective example embodiments and modification examples, each cathode 830 may be formed such that the porosity of the cathode 830 is higher at the downstream side than at the upstream side. According to this structure, the gas permeability of the cathode 830 is lower at the downstream side than at the upstream side. As such, the leak-gas does not stagnate in the downstream region of the anode-side porous portion 840 (fuel-gas supply passage) but it returns to the cathode 830. Thus, the leak gas from the cathode 830 does not stagnate in the anode-side porous portion 840 (fuel-gas supply passage).

In the fuel cell units of the respective example embodiments and modification examples, an ejector may be provided in the anode-side porous portion 840 so that fuel gas is circulated in the anode-side porous portion 840 (fuel-gas supply passage) by the “jet pump” effect. In this case, in the anode-side porous portion 840, the direction in which the fuel gas flows into the ejector corresponds to the downstream side (the downstream direction), and the opposite direction corresponds to the upstream side (the upstream direction).

While the foregoing fuel cell units of the respective example embodiments and modification examples have a dead-end structure, the invention is not limited to this. That is, the invention may be applied to any fuel cell unit that generates power without discharging fuel gas. One example of “fuel cell unit that generates power without discharging fuel gas” is as follows. This fuel cell unit has a fuel-gas discharge manifold, a fuel-gas discharge passage communicating with the fuel-gas discharge manifold and used to discharge the fuel gas from the anode-side porous portion 840 (fuel-gas supply passage) and a purge valve that interrupts discharge of fuel gas to the outside of the fuel cell unit when closed. This fuel cell unit performs power generation with the purge valve closed, that is, without discharging the fuel gas to the outside of the fuel cell unit as long as the values of parameters related to the supply amounts of the fuel gas and the oxidizing gas and the parameters related to power generation (e.g., the amount of generated power) are within given ranges and the nitrogen partial pressure at the anode and the nitrogen partial pressure at the cathode are substantially in equilibrium.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A fuel cell that generates power without discharging fuel gas, comprising:
an electrolyte membrane;
an anode provided on one side of the electrolyte membrane; and
a fuel-gas passage portion provided on the outer side of the anode to form a fuel-gas supply passage through which fuel gas is supplied to the anode, wherein
the gas permeability of at least one of the electrolyte membrane and the anode in a thickness direction thereof varies from position to position in a direction the fuel-gas supply passage extends.

2. The fuel cell according to claim 1, wherein a portion of the electrolyte membrane that corresponds to the downstream side of the fuel-gas supply passage and a portion of the electrolyte membrane that corresponds to the upstream side of the fuel-gas supply passage are made of different materials.

3. The fuel cell according to claim 1, wherein the thickness-direction gas permeability of the at least one of the electrolyte membrane and the anode is higher at a portion corresponding to the downstream side of the fuel-gas supply passage than at a portion corresponding to the upstream side of the fuel-gas supply passage.

4. The fuel cell according to claim 1, wherein the thickness of the electrolyte membrane is smaller at a portion corresponding to the downstream side of the fuel-gas supply passage than at a portion corresponding to the upstream side of the fuel-gas supply passage.

5. The fuel cell according to claim 1, wherein a portion of the electrolyte membrane that corresponds to the downstream side of the fuel-gas supply passage is made of fluorine resin and a portion of the electrolyte membrane that corresponds to the upstream side of the fuel-gas supply passage is made of hydrocarbon resin.

6. The fuel cell according to claim 1, wherein the porosity of the anode is higher at a portion corresponding to the downstream side of the fuel-gas supply passage than at a portion corresponding to the upstream side of the fuel-gas supply passage.

7. The fuel cell according to claim 1, wherein a plurality of concave portions is formed on an anode-side face of the electrolyte membrane.

8. The fuel cell according to claim 1, further comprising
a conductive sheet portion provided between the anode and the fuel-gas passage portion and having a sheet-like shape and having a plurality of through holes dispersedly formed in a surface of the conductive sheet portion, wherein
a plurality of concave portions is formed on the electrolyte membrane so as not to overlap the through holes of the conductive sheet portion as viewed in a direction the electrolyte membrane, the anode, and the conductive sheet portion are stacked to form a stack module.

9. The fuel cell according to claim 1, wherein the thickness-direction gas permeability of the at least one of the electrolyte membrane and the anode is lower at a portion corresponding to the downstream side of the fuel-gas supply passage than at a portion corresponding to the upstream side of the fuel-gas supply passage.

10. The fuel cell according to claim 1, wherein the thickness of the electrolyte membrane is larger at a portion corresponding to the downstream side of the fuel-gas supply passage than at a portion corresponding to the upstream side of the fuel-gas supply passage.

11. The fuel cell according to claim 1, wherein a portion of the electrolyte membrane that corresponds to the downstream side of the fuel-gas supply passage is made of hydrocarbon resin and a portion of the electrolyte membrane that corresponds to the upstream side of the fuel-gas supply passage is made of fluorine resin.

12. The fuel cell according to claim 1, wherein the porosity of the anode is lower at a portion corresponding to the downstream side of the fuel-gas supply passage than at a portion corresponding to the upstream side of the fuel-gas supply passage.

13. The fuel cell according to claim 1, wherein the minimum value of the pressure of fuel gas flowing in the fuel-gas supply passage is set larger than the maximum value of the partial pressure of leak gas that leaks from the cathode side to the fuel-gas supply passage through the electrolyte membrane.

14. A fuel cell that generates power without discharging fuel gas, comprising:
an electrolyte membrane;
an anode provided on one side of the electrolyte membrane;
a cathode provided on the other side of the electrolyte membrane; and
an oxidizing-gas passage portion provided on the outer side of the cathode to form an oxidizing-gas supply passage through which oxidizing gas is supplied to the cathode, wherein
the gas permeability of the cathode in a thickness direction thereof is higher at a portion corresponding to the downstream side of the oxidizing-gas supply passage than at a portion corresponding to the upstream side of the oxidizing-gas supply passage.

15. The fuel cell according to claim 2, wherein the thickness-direction gas permeability of the at least one of the electrolyte membrane and the anode is higher at a portion corresponding to the downstream side of the fuel-gas supply passage than at a portion corresponding to the upstream side of the fuel-gas supply passage.

16. The fuel cell according to claim 9, wherein the thickness of the electrolyte membrane is larger at a portion corresponding to the downstream side of the fuel-gas supply passage than at a portion corresponding to the upstream side of the fuel-gas supply passage.

17. The fuel cell according to claim 10, wherein a portion of the electrolyte membrane that corresponds to the downstream side of the fuel-gas supply passage is made of hydrocarbon resin and a portion of the electrolyte membrane that corresponds to the upstream side of the fuel-gas supply passage is made of fluorine resin.

18. The fuel cell according to claim 11, wherein the porosity of the anode is lower at a portion corresponding to the downstream side of the fuel-gas supply passage than at a portion corresponding to the upstream side of the fuel-gas supply passage.

19. The fuel cell according to claim 2, wherein the thickness-direction gas permeability of the at least one of the electrolyte membrane and the anode is lower at a portion corresponding to the downstream side of the fuel-gas supply passage than at a portion corresponding to the upstream side of the fuel-gas supply passage, wherein the porosity of the anode is lower at a portion corresponding to the downstream side of the fuel-gas supply passage than at a portion corresponding to the upstream side of the fuel-gas supply passage.

20. The fuel cell according to claim 2, wherein the thickness-direction gas permeability of the at least one of the electrolyte membrane and the anode is lower at a portion corresponding to the downstream side of the fuel-gas supply passage than at a portion corresponding to the upstream side of the fuel-gas supply passage,
wherein the thickness of the electrolyte membrane is larger at a portion corresponding to the downstream side of the fuel-gas supply passage than at a portion corresponding to the upstream side of the fuel-gas supply passage,
wherein a portion of the electrolyte membrane that corresponds to the downstream side of the fuel-gas supply passage is made of hydrocarbon resin and a portion of the electrolyte membrane that corresponds to the upstream side of the fuel-gas supply passage is made of fluorine resin,
wherein the porosity of the anode is lower at a portion corresponding to the downstream side of the fuel-gas supply passage than at a portion corresponding to the upstream side of the fuel-gas supply passage.
